(19) United States
(12) Patent Application Publication
(10) Pub. No.: US 2014/0375124 A1
(43) Pub. Date: Dec. 25, 2014

(54) Externally controllable battery charger having a signal interpreter

(71) Applicant: Carl Lee Danner, Bakersfield, CA (US)

(72) Inventor: Carl Lee Danner, Bakersfield, CA (US)

(21) Appl. No.: 13/924,649

(22) Filed: Jun. 24, 2013

(51) Int. Cl. H02J 7/00

(52) U.S. Cl. CPC H02J 7/0004
USPC 307/24

(57) ABSTRACT

In a first embodiment a first signal generator associated with a first power consuming device sends information about the first power consuming device to a signal interpreter associated with a controllable power source. The signal interpreter develops a control signal in response to the information. The control signal is sent to a controllable power source. The controllable power sends power to the first power consuming device in accordance with the control signal it receives from the signal interpreter. The first signal generator and the first power consuming device that is associated with it are abbe to be removed so that a second signal generator associated with a second power consuming device may communicate with the signal interpreter. The controllable source sends power to the second power consuming device in accordance with the control signal it receives from the signal interpreter.

A second embodiment is the same as the first except now the signal interpreter is able to understand commands from a signal generator that develops commands instead of information.

### REFERENCES CITED

### U.S. Patent Documents

| | | |
|---|---|---|
| 7,844,370 | November 2010 | Pollack et al. |
| RE41,675 | May 2006 | Liu et al. |
| 7,414,332 | August 2008 | Ohsuga |
| 7,411,371 | August 2008 | Hobbs |
| 5,404,090 | April 1995 | Shinbori |
| 2003/018,934 | October 2003 | Bushue et al. |

### RELATED US PATENT APPLICATIONS

U.S. Ser. No. 13,088,429 has been allowed for issuance as a patent but is not yet issued. The application relates to externally controllable power supplies.

U.S. Ser. No. 13,350,950 relates to controlling power by sending a power request to an interpreter.

U.S. Ser. No. 13,712,967 relates to controlling power by sending power directions such as increase power or decrease power to an interpreter.

U.S. Ser. No. 13,750,029 relates to controlling power by sending information about the power consuming device to an interpreter.

### DESCRIPTION

1. Field of the Invention

This invention relates to power consuming or power storing devices, and more particularly to an improved method of providing appropriate power to power consuming or power storing devices.

2. Background of the Invention

The applications mentioned above except U.S. Ser. No. 13,088,429 are specific implementations of the general principle of controlling a power source by using an interpreter that is associated with a controllable power source to create a power control signal from either information about a power consuming device or by using an interpreter to create a power control signal from power commands such as a power request or a command to increase or decrease power.

It is therefore, an object of the present invention to use an interpreter to decode information about a power consuming device and to develop a control signal to control a power source so as to provide an appropriate power to a power consuming or power storing device. It is a further object of the present invention to use an interpreter to decode a power command from a signal generator associated with a power consuming device and to develop a control signal to control a power source so as to provide a power in accordance with the power command.

### SUMMARY OF THE INVENTION

In accordance with these and other objects of the invention, there is provided in a first embodiment a first signal generator that is associated with a first power consuming device. The first signal generator sends information about the first power consuming device to an interpreter. The interpreter develops and sends a control signal to a controllable power source. The controllable power source delivers power to the first power consuming device. The power is specified by the control signal from the interpreter. A second signal generator and a second power consuming or power storing device has power needs that are different from the power needs of the first power consuming or power storing device. The interpreter develops and sends a control signal to the controllable power source. The controllable power source delivers power to the second power consuming device. The power is as specified by the control signal from the interpreter.

In a second embodiment there is provided an interpreter that is the same as in the first embodiment except that this interpreter is able to respond to commands from a signal generator associated with the power consuming or power storing device. The commands may be a power request or a command to increase or decrease power provided to the power consuming or power storing device.

### BRIEF DESCRIPTION OF THE DRAWINGS

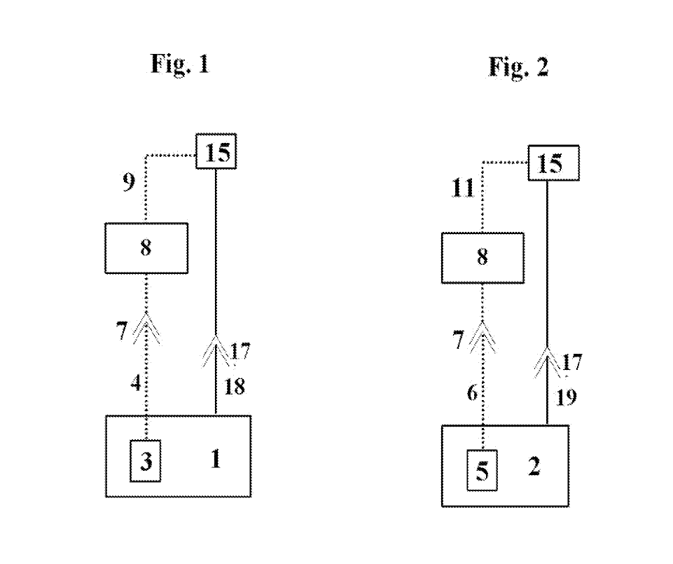

The foregoing and other objects and features of the present invention can be more readily understood with reference to the following description taken in conjunction with accompanying drawings, wherein like reference numerals designate like electrical elements and in which the same power source delivers power to two different power consuming devices in turn as each device is attached to the externally controllable power supply. A first device is shown in FIG. 1 and another device is shown in FIG. 2.

### DETAILED DESCRIPTION OF THE INVENTION

Although the present invention is described herein with reference to controlling electrical power by way of example, it is to be clearly understood that the principles of the invention are applicable to providing other types of power. The invention has been described in connection with electricity because electricity is commonly understood. It should be obvious that the principles of the invention can be applied to other types of power.

Referring now to FIG. 1 of the drawings, a block diagram of a controllable power source that is using an interpreter is shown. Power consuming device 1 has an associated signal generator 3 that may send information or commands to 4 to interpreter 8 via jack/plug 7. Interpreter 8 develops a power source control signal 9 that controls power source 15 so as to deliver power 18 to power consuming device 1 via jack/plug 17.

Referring now to FIG. 2 of the drawings, the same interpreter 8 controls the same power source 15. A different power consuming device 2 is now receiving power 19. Power 19 may be different than power 18 of FIG. 1 because power consuming device 2 may have different power needs. Power consuming device 2 is associated with signal generator 5. Signal generator 5 sends information or commands 6 to interpreter 8 via jack/plug connection 7. Interpreter 8 sends power source control signal 11 to controllable power source 15. Power source 15 sends power 19 to power consuming device 2 via jack/plug 17,

Thus there have been shown and described methods that allow flexible control of electric power by using a signal generator that is associated with a power consuming device and an interpreter that is associated with a controllable power source. The signal generator sends information about its associated power consuming device or the signal generator sends commands that it creates as a result of knowing characteristics and status of its associated power consuming or power storing device to the interpreter that decode the communication from the signal generator and develops a signal to control a controllable power source so as to deliver power to the power consuming or power storing device. It is to be understood that the above describe embodiments are merely illustrative of the many possible specific embodiments which represent applications of the principles of the present invention. Numerous and varied other arrangements can be readily devised in accordance with these principles by those skilled in the art without departing from the spirit and scope of the invention.

What is claimed is:

1. A power delivery system capable of providing power to devices requiring different power types or levels comprising:
means to develop information about a first power consuming or power storage device;
means to provide said information about said first power consuming or power storage device to an interpreter, said interpreter capable of using said information about said first power consuming or power storage device to develop a first power source control signal;
a power source capable of providing power in response to a control signal;
means to deliver power from said power source to said first power consuming or power storage device, said power source controlled by said first power source control signal;
means to deliver power from said power source to said first power consuming or power storage device, said power source controlled by said first power source control signal;
means to remove said means to develop information about a first power consuming or storage device;
means to remove said first power consuming or power storage device;
means to install a second power consuming or power storage device;
means to install means to develop information about said second power consuming or storage device;
means to provide said information about said second power consuming or power storage device to said interpreter, said interpreter capable of using said information about said second power consuming or storage device to develop a second power source control signal that controls said power source;
means to deliver power form said power source to said second power consuming or storage device.

2. A power delivery system capable of providing power to devices requiring different power types or levels comprising:
means to develop a power command that, if followed, will result in power being delivered to a first power consuming or power storage device;
means to send said command to an interpreter, said interpreter capable of using said command to develop a first power source control signal;
a power source capable of providing power in response to a control signal;
means to deliver power in response to said first power source control signal to said first power consuming or power storage device, said power source controlled by said first power source control signal;
means to remove said means to develop a power command that will result in power being delivered to a first power consuming or power storage device;
means to remove said first power consuming or power storage device;
means to install a second power consuming or power storage device;
means to install means that, if followed, will result in power being delivered to said second power consuming or power storage device;
means to send said command to said interpreter, said interpreter developing a second control signal for use by said controllable power source;
means to deliver power from said power source to said second power consuming or storage device.
